(19) United States
(12) Patent Application Publication
(10) Pub. No.: US 2003/0181223 A1
(43) Pub. Date: Sep. 25, 2003

(54) System and method for voice activated dialing

(75) Inventors: Chinmei C. Lee, Woodridge, IL (US); Peter A. Lin, Lisle, IL (US)

Correspondence Address: Fay, Sharpe, Fagan, Minnich & McKee, LLP, Seventh Floor, 1100 Superior Avenue, Cleveland, OH, 44114-2518, US

(73) Assignee: LUCENT TECHNOLOGIES INC.

(21) Appl. No.: 10/105,653

(22) Filed: Mar. 25, 2002

(51) Int. Cl. H04B 1/38

(52) U.S. Cl. 455/563; 455/564

(57) ABSTRACT

A method for voice activated dialing of a wireless voice communication terminal is provided. The method includes connecting the wireless voice communication terminal to an application server of a voice activated dialing service provider and collecting requested party information at the application server over a voice network. The method also includes providing a phone number of the requested party as data and delivering the requested party phone number data to the wireless voice communication terminal over a data network. A data assisted voice activated dialing system is provided which receives spoken requested party identification information from a user operated wireless voice communication terminal over a voice network. In response, the server provides the requested party phone number as data to the wireless voice communication terminal over a data network.

### BACKGROUND OF THE INVENTION

The present invention relates to wireless communications and more particularly to voice activated dialing with a wireless voice communications terminal using a voice network and data network.

Wireless voice communication terminals, such as cellular phones, are commonly used for mobile voice communication. Wireless voice communication terminals, hereinafter called “wireless terminals”, place calls to phones, including other wireless terminals and conventional land-line telephones, over a wireless interface using a voice network. Placing a call typically requires dialing the phone number of the called party.

Efforts have been made to simplify the calling process. Voice activated dialing generally includes speaking the name of the called party and completing the call without the caller having to remember the phone number and manually dial it. Voice activated dialing uses speech recognition processing to convert voice commands into machine instructions necessary to complete the call.

A known voice activated dialing system uses wireless terminals capable of performing the necessary speech recognition processing. However, wireless terminals capable of speech recognition processing are typically sophisticated and more expensive.

Accordingly, it is desirable to provide a new and improved system and method of voice activated dialing for wireless terminals which do not have the computing power necessary for speech recognition.

### SUMMARY OF THE INVENTION

According to the present invention, a method for voice activated dialing of a wireless voice communication terminal is provided.

In accordance with a first aspect of the invention, the method includes connecting the wireless voice communication terminal to an application server of a voice activated dialing service provider and collecting requested party information at the application server over a voice network. The method also includes providing a phone number of the requested party as data and delivering the requested party phone number data to the wireless voice communication terminal over a data network. The method further includes automatically disconnecting the wireless voice communication terminal from the application server and automatically dialing the requested party phone number on the wireless voice communication terminal.

Further, according to the present invention, a data assisted voice activated dialing system is provided. The system receives spoken requested party identification information from a user operated wireless voice communication terminal over a voice network. In response, the system provides the requested party phone number as data to the wireless voice communication terminal over a data network.

Other features, benefits and advantages of this invention will become apparent to those skilled in the art from the following detailed description of the preferred embodiments, when read in light of the accompanying drawings.

### BRIEF DESCRIPTION OF THE DRAWINGS

The invention may take form in certain components and structures, preferred embodiments of which will be illustrated in the accompanying drawings wherein:

FIG. 1 is a block diagram including a voice activated dialing system in accordance the present invention;

FIG. 2 is a flow chart of a method of voice activated dialing in accordance with the invention;

FIG. 3 is flow chart of the step of collecting requested party information shown in FIG. 2; and

FIG. 4 is flow chart of the step of providing the requested party phone number as data shown in FIG. 2.

### DETAILED DESCRIPTION OF THE INVENTION

It is to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting.

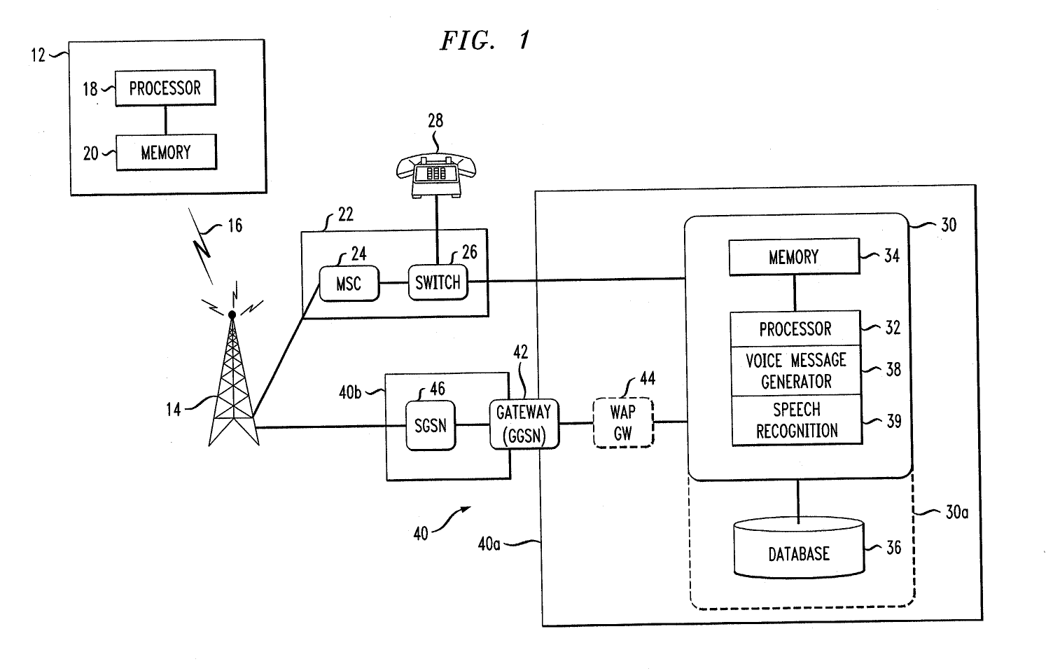

Referring now to FIG. 1, a Data Assisted Voice Activated Dialing (hereinafter called DAVAD) system is shown generally at 10 for connecting a user operated wireless terminal to another terminal, hereinafter called the requested party, via a voice network. The DAVAD system 10 includes a wireless terminal 12 for communicating with a base station 14 via a wireless interface 16. The wireless terminal 12 is a wireless voice and data device, such as a data capable cellular phone, for providing voice communication and receiving data. The wireless terminal 12 includes a processor 18 for executing computer program instructions and controlling the operation of the wireless terminal. The processor 18 is connected to conventional memory 20 for storing computer program instructions as well as phone numbers and other data.

The base station 14 is connected to a conventional circuit voice network 22 which includes a mobile switching center (MSC) 24. The MSC 24 is typically connected to more than one base station 14, though for clarity, only one base station is shown in FIG. 1. Each base station 14 provides wireless communication to wireless terminals, such as wireless terminal 12, operating within the geographic area, such as a cell, served by the base station.

The voice network 22 also includes conventional switches 26 connected to the MSC 24 for connecting the MSC to the requested party's phone 28 to provide voice communication between the wireless terminal 12 and the requested party 28 in a known manner. The switches 26 can include switches configured in any suitable known manner including but not limited to switches provided by the wireless service provider servicing the wireless terminal 12, and/or switches provided by the wireless service provider servicing the requested party 28, and/or switches provided by the public switched telephone switching network.

In accordance with the invention, the voice network switches 26 also connect the MSC 24 to a voice activated dialing service provider's application server 30. The application server 30 is controlled by a processor 32 for executing computer program instructions. The processor 32 is connected to conventional memory 34 for the storage of computer program instructions and other data.

The processor 32 is also connected to a database 36 which stores phone numbers of the requested party 28 for access by users of the wireless terminal 12 who subscribe to the service provider which provides the voice activated dialing as shall be described below. The database 36 can be part of a data network 40a described below, such as the Internet. Alternatively, the database can be stored in the application server 30 as indicated by the dashed line 30a.

The application server 30 further includes a voice message generator 38 for verbally prompting the user of the wireless terminal 12 to provide spoken information. The voice message generator 38 can be any known structure and/or method for producing and transmitting spoken commands to the user at the wireless terminal 12 over the voice network 22. The processor 32 further includes speech recognition functionality 39 for converting user spoken words transmitted from the wireless terminal and received by the application server 30 to machine readable code for directing processing and for storing data as shall be described below.

The application server 30 is connected to a data network 40 for transferring data structures from the application server 30 to the base station 14 for wireless transmission to the wireless terminal 12 in a known manner. In one example, which should not be considered limiting, the data network 40 can include a wired data network 40a and a wireless data network 40b.

The DAVAD system 10 can further include a gateway 42 for connecting the wired data network 40a to the wireless data network 40b for transferring data therebetween. The gateway 42 can be any known gateway, including but not limited to a GGSN (Gateway GPRS Service Node) 42.

The wired data network 40a can be any known wired data network which can include a packet data network such as the Internet. The wired data network 40a can include a conventional Wireless Application Protocol (WAP) gateway 44 for communicating with wireless terminals 12 which use WAP to communicate with a data network.

The wireless data network 40b can be any known wireless data network for transferring data structures to the base station 14 for wireless transmission to the wireless terminal 12 in a known manner. The wireless data network 40b is adapted for wireless transmission of data in any known manner. The wireless data network 40b can include a known SGSN (Serving GPRS Service Node) 46 for transferring data structures to the base station 14 for wireless transmission to the wireless terminal 12.

The data structures can be any known form of data, including but not limited to text files, which include the phone number of the requested party 28. Further, the data can be provided in any known manner, such that it is in the correct language and format for proper interpretation by the wireless terminal 12 as shall be described in further detail below.

One skilled in the art will recognize that for the purposes of clarity, FIG. 1 is a high level functional block diagram. The detailed architectures of both the voice network 22 and the data network 40 are well known in the art. The finer details of these networks 22, 40 are not important for understanding the present invention and therefore have been omitted from FIG. 1 for clarity.

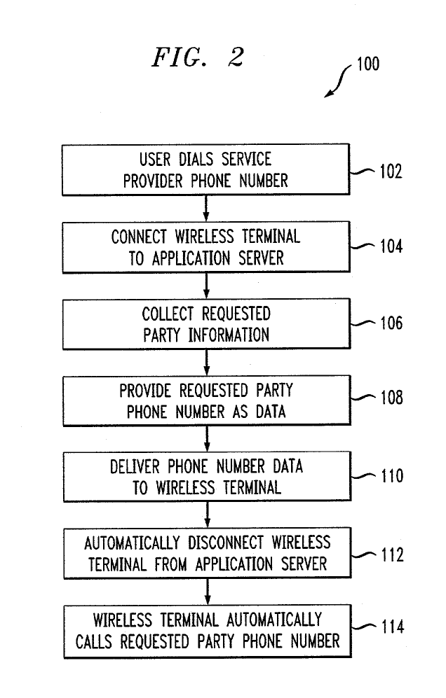

The operation of the DAVAD system 10 shall be described in reference to the method for voice activated dialing as illustrated in FIGS. 2-4. The steps performed in accordance with the invention for connecting a user operated wireless terminal 12 to a requested party 28 over a voice network 22 having a wireless interface 16, wherein the wireless terminal 12 is capable of receiving data from a data network 40 having a wireless interface 16 is shown generally at 100 in FIG. 2.

In step 102 the user of the wireless terminal 12 dials the phone number of the DAVAD service provider on the wireless terminal. The phone number can be stored in the wireless terminal memory 20, in which case the user may speed dial the phone number in a conventional manner by pressing a minimum number of buttons. The phone number can be a toll free phone number, or any other suitable phone number.

The wireless terminal 12 is then connected to the application server 30 of the voice activated dialing service provider over the conventional voice network 22. This is accomplished in a known manner, such as for example, the MSC 24 routing the call via switch 26 to the service provider server 30.

Upon establishing the voice connection, the application server 30 makes voice announcement requesting the user to speak the identity of the requested party and collects the requested party information from the user at 106 in a manner that shall be described in further detail below. The processor 32 then generates a data structure including the requested party phone number at 108 in a manner which shall be described in further detail below. The data structure is delivered to the wireless terminal processor 18 over the data network 40 at 110 in any suitable known manner.

After the wireless terminal 12 receives the data structure, the application server 30 disconnects the voice connection with the wireless terminal 12 at 112 in a known manner. Alternatively, the wireless terminal processor 18 can disconnect the voice connection in a known manner upon receiving the data structure. The wireless terminal processor 18 then automatically calls the requested party phone number included in the data structure at 114 thereby forming a wireless voice connection with the requested party 28. “Automatically”, as used herein, refers to performing an automated task in a known manner, preferably via processor control, rather than a user performing the task manually.

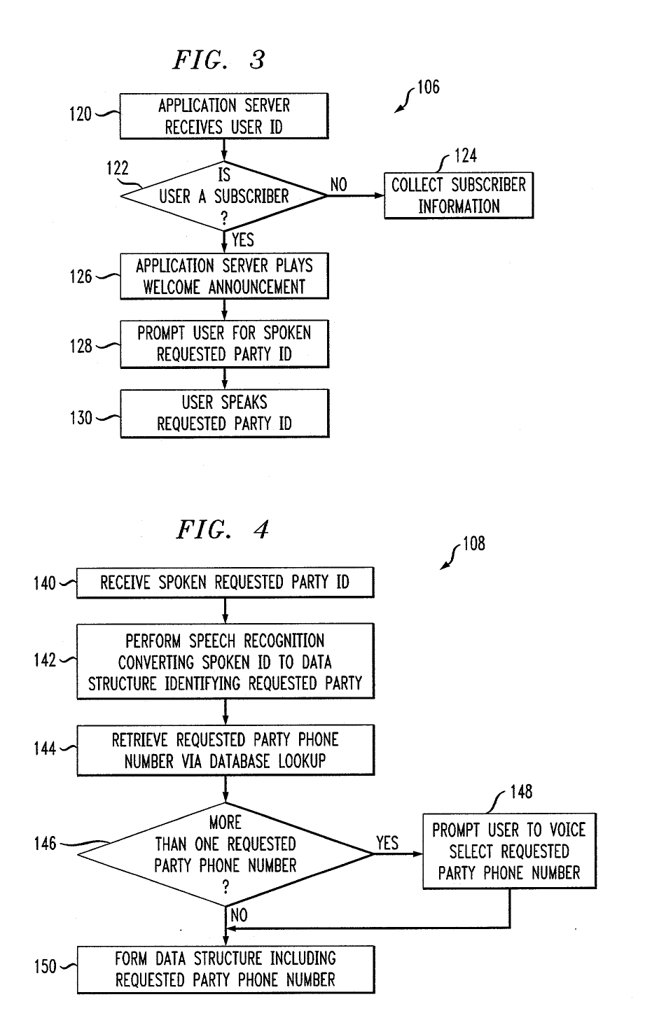

Referring to FIG. 3, the steps performed to collect information from the user, including the requested party information, at 106 are discussed in further detail. Upon establishing the voice connection between the wireless terminal 12 and the application server 30, the application server processor 32 receives a user identification at 120 identifying the wireless terminal 12 in a known manner. The wireless terminal's user ID will typically be provided to the application server 30 via voice connection signaling in a known manner. If it is not, the application server voice message generator 38 may provide an announcement to the user to collect the user ID.

The user ID, is compared to a list of subscribers stored by the application server 30, in memory 34 or the database 36, to determine if the user is a subscriber at 122. If the user is not a subscriber, the application server processor 32 enters a subroutine at 124 verbally prompting the user to supply the spoken information needed enable the user to subscribe to the voice assisted dialing service. Examples of the spoken information can include, but are not limited to, the user's name, address and billing information. The application processor 32 establishes a subscription account for the new user, storing this information in the database 36 in a known manner. The application processor 32 can then collect spoken requested party identification information and the associated phone numbers from the new subscriber which can be added to the database for subsequent retrieval.

If the user is a subscriber, the application server processor 32 sends a verbal welcome announcement to the user's wireless terminal at 126 over the voice network 22, and prompts the user to provide a spoken requested party ID at 128. The spoken requested party ID identifies the party that the user wants to call. The user then speaks the requested party ID into the wireless terminal at 130. The spoken requested party ID can be the name of the requested party, such as for example “John Smith”, or nicknames, or any other suitable spoken identification of persons, places, things, etc.

Referring to FIG. 4, the steps performed to provide the requested party phone number as data at 108 shall now be discussed in further detail. As a result of collecting the requested party information at 106 described above, the application server processor 32 receives the spoken identification identifying the requested party at step 140 over the voice network 22. The processor speech recognition block 39 performs speech recognition in a known manner to convert the spoken requested party ID to a data structure identifying the requested party at 142.

The user ID is used as a key to the database 36 that stores phone numbers of all requested parties for the user. After the requested party's ID is provided at 130 and converted to a usable data structure at 142, the processor 32 retrieves the requested party phone number associated with the data structure and the user ID from the data base 36 using known database lookup methods at 144.

The data structure identifying the requested party and the associated requested party phone number can be initially stored in the database 36 by each subscriber in a variety of known manners. For example, the processor 32 may provide a prompt, as generated by the voice message generator 38, asking for new requested party information. This prompt can be initiated by the user, for example by using a menu. Alternatively, if the processor 32 does not locate the requested party phone number in step 108, the processor may initiate the prompt to add the new requested party information to the database 36.

The user may add the new requested party information via the voice network 22. Alternatively, the user may add the new requested party information to the database 36 via the data network 40, such as for example, by accessing a web site, transferring data from the wireless terminal 12, or in any other known manner.

The processor 32 may optionally determine if more than one requested party phone number is associated with the requested party ID at step 146. If more than one phone number exists, the voice message generator 38 prompts the user to select the desired requested party phone number using voice commands at 148.

A data structure including the requested party phone number is then formed at 150 in any suitable known manner. The data shall be in any known format that is compatible with the programming of the terminal processor 18. In one example which should not be considered as limiting, for a WAP based terminal 12, an XML file including the phone number may be formed by the application server 30 and pushed, or transferred, to the terminal's WAP wireless Telephony Application client for it to start making a telephony call. In another example, the data structure can be formatted into a Wireless Markup Language (WML) for delivery to the browser of the WAP terminal 12.

To send the requested party phone number back to the user's terminal 12 via the data network 40, the address, such as an IP address, of the wireless terminal 12 is obtained. The address can be obtained in any known manner. In an example which should not be considered limiting, the wireless terminal 12 address can be retrieved from the database 36 which can be used to maintain a mapping of the user ID and the associated IP address of the terminal 12, such as a dynamic Domain Name Server (DNS) The DNS is often located in the data network 40 external to the application server 30 and can be reached or consulted by many applications.

The invention provides a flexible, cost effective alternative to known voice activated dialing systems and methods. The voice activated dialing service provider can be independent from the wireless access provider, using conventional telephone land lines. The invention provides the user more choices for the service resulting in more competition and lower prices for subscribers. Further, subscribers can access the voice activated dialing service while roaming providing flexible usage. The invention can utilize known data networks, incorporating any known internet infrastructures.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

We claim:

1. A method for voice activated dialing for connecting a user operated wireless voice communication terminal to a requested party terminal over a wireless interface via a voice network, wherein the wireless voice communication terminal is capable of receiving data from a data network over the wireless interface, the method comprising:
connecting the wireless voice communication terminal to an application server of a voice activated dialing service provider;
collecting requested party information at the application server from the wireless voice communication terminal over the voice network;
providing a phone number of the requested party as data at the application server;
delivering the requested party phone number data to the wireless voice communication terminal;
automatically disconnecting the wireless voice communication terminal from the application server; and
automatically dialing the requested party phone number on the wireless voice communication terminal.

2. The method for voice activated dialing defined in claim 1 wherein the collecting step further comprises the application server receiving user identification for determining whether the user is a subscriber.

3. The method for voice activated dialing defined in claim 2 wherein the collecting step further comprises collecting subscriber information from a new subscriber.

4. The method for voice activated dialing defined in claim 2 wherein the collecting step further comprises prompting the user to provide a spoken requested party identification.

5. The method for voice activated dialing defined in claim 4 wherein the collecting step further comprises the user providing a spoken identification of the requested party.

6. The method for voice activated dialing defined in claim 5 wherein the collecting step further comprises prompting the user to voice select one phone number among several phone numbers associated with the requested party.

7. The method for voice activated dialing defined in claim 5 wherein the providing step further comprises performing speech recognition to convert the spoken identification to a data structure identification of the requested party.

8. The method for voice activated dialing defined in claim 7 wherein the providing step further comprises retrieving the phone number of the requested party from a database.

9. The method for voice activated dialing defined in claim 1 wherein the delivering step further comprises:
transferring the data to a base station over a data network; and
transmitting the data from the base station to the wireless voice communication terminal over a wireless interface.

10. The method for voice activated dialing defined in claim 1 wherein the connecting step further comprises dialing a phone number of the service provider.

11. The method for voice activated dialing defined in claim 10 wherein the connecting step further comprises retrieving the phone number of the service provider from memory in the wireless voice communication terminal.

12. The method for voice activated dialing defined in claim 1 wherein the connecting step further includes connecting the wireless voice communication terminal to the application server with a mobile switching center.

13. The method for voice activated dialing defined in claim 1 wherein the data provided in the providing step is a text based file.

14. A data assisted voice activated dialing system for receiving requested party identification information from a user operated wireless voice communication terminal over a voice network and providing requested party phone number data to the wireless voice communication terminal over a data network, the system comprising:
a processor for executing computer program instructions;
a voice message generator for prompting the user of the wireless voice communication terminal to provide spoken requested party identification information;
speech recognition means for converting said spoken requested party identification information to a data structure identifying the requested party; and
a database connected to said processor for storing requested party phone number data associated with said data structure identifying the requested party, wherein the processor retrieves said requested party phone number data from said database and delivers said requested party phone number data to the data network for transmission to the wireless voice communication terminal.

15. The data assisted voice activated dialing system defined in claim 14 further including an application server, wherein said server includes said processor, said voice message generator and said speech recognition means.

16. The data assisted voice activated dialing system defined in claim 15 wherein application server includes said database.

17. The data assisted voice activated dialing system defined in claim 14 further including a wired data network, wherein said database is included in said wired data network.

18. The data assisted voice activated dialing system defined in claim 14 further including a wireless data network for wirelessly transmitting the requested party phone number data to the wireless voice communication terminal.

19. The data assisted voice activated dialing system defined in claim 14 further including a voice network including a mobile switching center.
